(19) United States
(12) Patent Application Publication
(10) Pub. No.: US 2002/0060624 A1
(43) Pub. Date: May 23, 2002

(54) Plug compatible power line communications network device

(76) Inventor: George Zhang, San Mateo, CA (US)

Correspondence Address: Harris Zimmerman, Law Offices of Harris Zimmerman, Suite 710, 1330 Broadway, Oakland, CA, 94612-2506, US

(21) Appl. No.: 09/854,449

(22) Filed: May 14, 2001

Related U.S. Application Data
(60) Provisional application No. 60/249,680, filed on Nov. 17, 2000.

(51) Int. Cl. H04M 11/04

(52) U.S. Cl. 340/310.01; 340/310.06

(57) ABSTRACT

A multi-point computer networking device for transmitting data over AC power lines is attached externally to a computer station. The networking device includes a power line data transceiver unit for placing data onto and taking data off of the power line. A male AC power plug conducts the AC power from an AC power outlet through an AC power cord to the computer device. Therefore, only one AC power cord is needed for each computer to serve both AC power and data networking functions.

### REFERENCE TO RELATED APPLICATION

This utility application claims priority based on Provision Application No. 60/249,680, filed Nov. 17, 2000.

### BACKGROUND OF THE INVENTION

The present invention relates in general to a computer networking system. More particularly, the present invention comprises an apparatus for providing networking capability to a computer and computer peripheral equipment via the main AC power cord of the computer and each peripheral device. The present invention also relates to a unique enclosure design.

A computer network includes a number of computers, printers, or other peripheral equipment (devices) that are linked together so as to permit individual devices to exchange data with one or more other devices on the network. Historically, the devices of a computer network have been linked together by dedicated wires. However, dedicated wiring has many drawbacks, such as high cost, inconvenience and installation difficulty, especially when expanding or reconfiguring the network system. To overcome these drawbacks, other alternative approaches have been developed for network communications media such as wireless and AC power lines.

In power line communications (PLC), network data is transmitted on an existing power line, in addition to the electrical AC line current already present for delivering electrical power. Using the power line as the medium for communications is particularly convenient because a power line will always be present to provide AC power to the various devices on a network. A number of PLC protocols (such as: X-10, CEBus, Lonworks and PowerPacket) have been developed, and chip sets employing them are commercially available, making the AC power line a feasible network communications medium.

There are a number of PLC patents issued. For example, U.S. Pat. No. 4,809,296 shows a structure of a PLC system using one kind of modulation scheme. However, it does not show how to implement the scheme as a network device. U.S. Pat. No. 5,684,826 shows how to build a RS-485 power line modem for data networks, but it does not show the application for commercial and personal computer devices. Moreover, RS-485 is an industrial communication scheme that is not suitable for commercial and personal computer applications, and the speed is too slow for computer local area network (LAN) applications such as Ethernet.

There are some PLC products that have been introduced commercially. For example, “PassPort” is built by Intelogis Inc., of Draper, Utah. It is a low speed (350 Kbps) wall plug-in PLC device which requires an extra long (1.5 meter) and heavy parallel cable to connect to a personal computer. This provides no advantage over a regular LAN system since they both require two separate cables (an AC power cord and a data cable).

### SUMMARY OF THE INVENTION

In order to simplify the installation of a PLC network system, the present invention provides a PLC network device that is external to, and removably secured to a computer system. The PLC networking system contains a female AC input socket, a male AC output plug, an EMI isolator, a PLC network transceiver, a DC distribution circuit and a bus interface.

Accordingly, several objects and advantages of my present invention are (1) By attaching the external PLC networking device to a computer apparatus, the installation is simplified. Also the data cable is very short, thereby reducing the attenuation and noise on the data cable. (2) The PLC networking system is able to obtain DC power from the computer, thereby reducing both the cost and size of the networking device by eliminating its own power supply and transformer. (3) Because the PLC networking system is connected between the main AC power cord and the computer's power input socket, electromagnetic interference (EMI) noise can be blocked by providing an EMI isolator in the PLC device to improve the quality and throughput of data communications. (4) The enclosure of the network device can be turned to different angles, in order to adapt to various computer housing configurations. Page 3

### BRIEF DESCRIPTION OF THE DRAWING

FIG. 1 is a functional block diagram showing the PLC network device of the present invention for forming a computer network.

FIG. 2 is an alternative embodiment of the PLC network device shown in FIG. 1.

FIG. 3 is a schematic diagram showing details of the EMI isolator depicted in the embodiment of FIG. 2.

FIG. 4 is a functional block diagram showing details of the DC power distributor shown in FIGS. 1 and 2.

FIG. 5 is an exploded perspective view of the PLC network device of the invention and its assembly to a typical computer apparatus.

FIG. 6 is an exploded perspective view of an alternative embodiment of the PLC network device of the invention and its assembly to a typical computer apparatus.

FIG. 7 is a plan view showing the rotatability of the PLC device of the invention with respect to a typical computer apparatus to which it is connected.

### DESCRIPTION OF THE PREFERRED EMBODIMENT

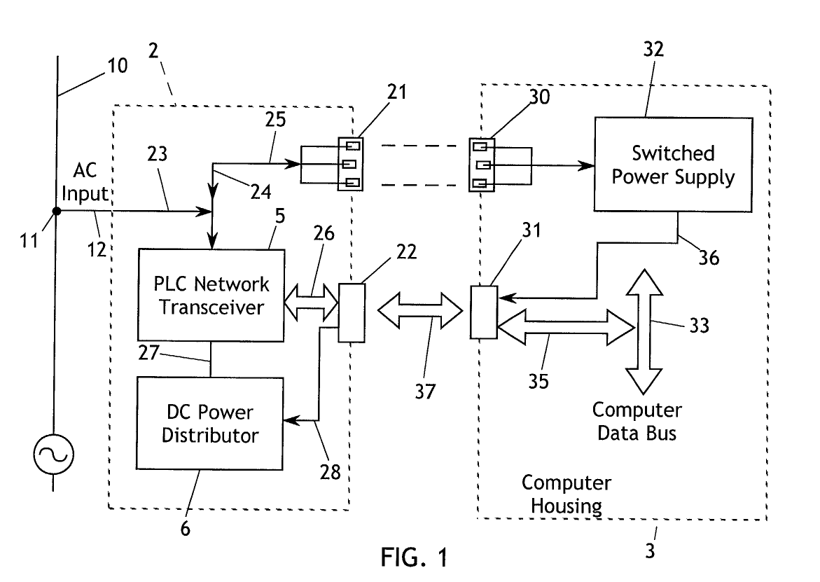

The present invention generally comprises a PLC network device that is external to, and removably secured to a computer system. With regard to FIG. 1, a PLC network device 2 handles PLC network data and serves a computer apparatus 3. A power line 10 is commonly found in commercial, industrial, institutional or residential buildings. Power line 10 may also be provided, for example, by a system of temporary power lines or extension cords such as might be set up at a trade show or exhibition for supplying electrical power to a number of computers, printers, or other peripheral equipment. The PLC network device 2 is connected to power line 10 through a conventional AC power cord 12 and AC power outlet box 11. The PLC network device 2 has a male AC output plug 21 that may be plugged into a computer power input socket 30. The male AC output plug 21 conducts AC power to the computer's switched power supply 32 from the power line 10.

The invention also includes a bus cable 37 that connects between the PLC network device 2 and the computer apparatus 3. At one end, the bus cable 37 is plugged in the bus connector 22 of the device 2 and, at the other end, to a bus connector 31 of the computer 3. The bus cable 37 not only transfers data between the device 2 and the computer 3, but also can may provide a small amount of DC power current (usually from 10 mA to few hundred mA) from the computer to the external device 2. This type of computer bus is commonly found in the prior art, such as the Universal Serial Bus (USB) or IEEE RS232 and thus need not be described in detail here. However the method of connection for PLC network device is unique:

Within the PLC network device 2, a data bus interface 26 and a DC input circuit 28 both connect to the bus connector 22. The DC input circuit 28 connects to a DC power distributor 6 that provides the DC operating power for the entire PLC network device 2 through a DC distribution circuit 27. The data bus interface 26 is connected to a PLC network transceiver 5 that exchanges base-band data with computer station 3.

Within the computer station 3 side, a DC output circuit 36 and a computer data bus interface 35 both connect to the computer bus connector 31. The DC output circuit 36 connects to a switched power supply 32 that is typically provided within the computer enclosure 3. The computer data bus interface 35 is connected to a computer data bus 33 that exchanges base-band data with the PLC network device 2.

The PLC network transceiver 5 transmits and receives a PLC signal 23 to and from the power line 10 as well as exchanges base-band data with the computer station 3. Since there are many commercial power line data transceivers modules available from multiple vendors, the structures, circuitry and principles are well known from other methods and thus need not be described in detail here.

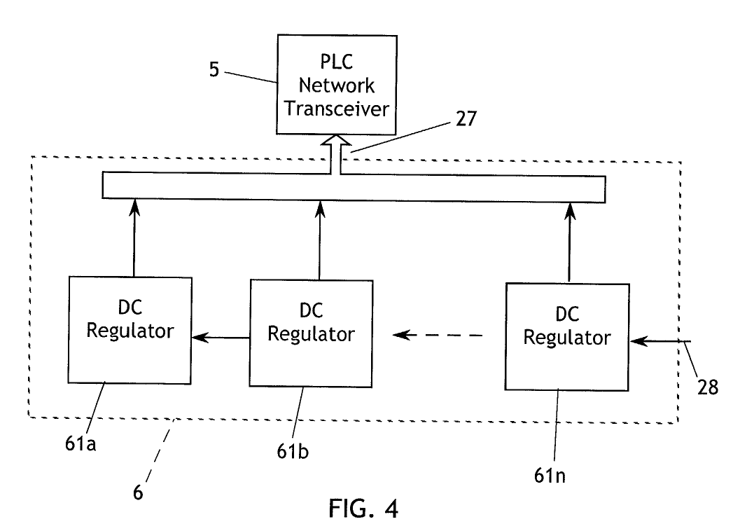

With regard to FIG. 4, the DC power distributor 6 provides the DC operating power source for the PLC network device 2. The PLC network device 2 needs multiple voltage power sources, such as +5V for logic circuitry, +5V and −5V for analog circuitry, +12V and −12V for transmitter amplifiers, etc. So the DC power distributor 6 contains multiple voltage regulators 61a-61n. Because the bus cable 37 only can provide a small amount of DC power current for the PLC network device 2, the power efficiency of voltage regulator 61 must be very high. Thus in the preferred embodiment one or more high efficiency switching voltage regulators are used.

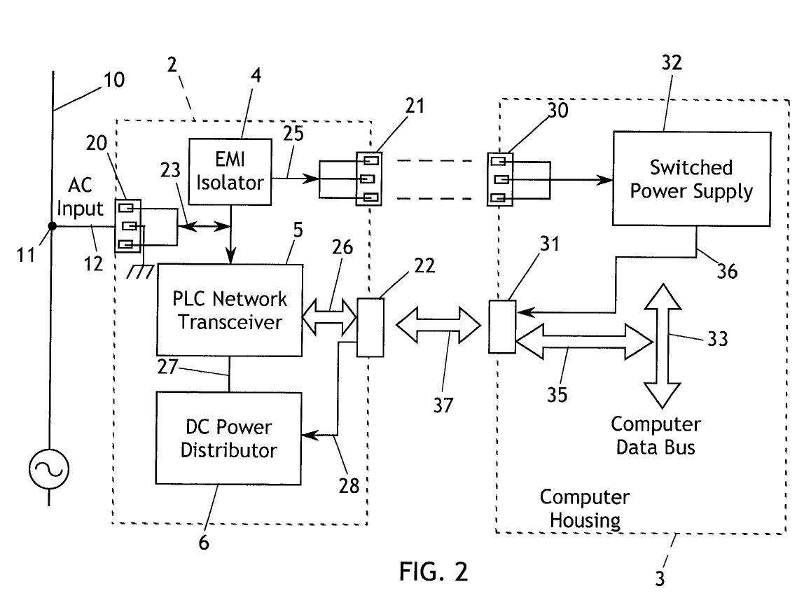

With regard to FIG. 2, an alternative embodiment of the PLC network device 2 includes all the components described previously. In addition, an electromagnetic interference (EMI) isolator 4 is connected between the AC input 12 and the plug connector 21. The particular manner in which the power line data transceiver is connected to the power line is important to the invention because the PLC signal on the power line is transferred through same power cable shared with the regular switched power supply 32. The regular switched power supply generates significant high frequency electromagnetic interference (EMI) noise 24 (shown in FIG. 1), and the EMI noise may transfer to the AC power input and thence to the PLC network transceiver 5. The frequency range of the EMI noise is from several kilohertz to several megahertz. It may interfere with the PLC signal, especially in high speed PLC systems. The result would be distortion of the PLC signal that would cause a high bit-error-rate (BER), a slowdown of data throughput, and even a jam of the communication channel (which is the power line). The EMI isolator 4 is provided to prevent the noise from the switched power supply from interfering with the PLC data signal to and from the PLC network transceiver 5.

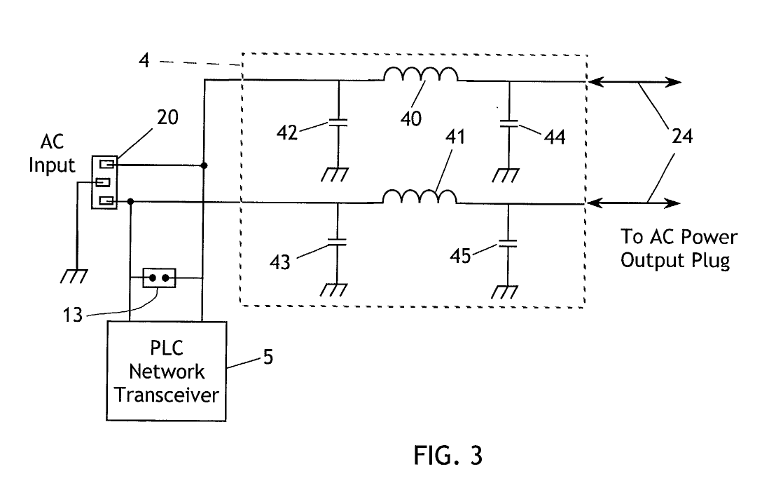

With regard to FIG. 3 the EMI isolator 4 generally comprises a LC low-pass filter. The LC low-pass filter contains two inductors 40 and 41 and paired capacitors 42 and 44, and 43 and 45, respectively, as a dual Pi-type LC low-pass filter. Alternatively, in order to reduce the size and cost of the PLC network device 2, only one inductor 40 and one capacitor 42 may be employed in an L-type LC filter. Because the capacitors are connected to the AC power main, surges are possible. Thus the working voltage of the capacitors should be at least 500V. Also a surge protector 13 is added to protect inside electrical circuitry. Since a high current will be passing through the inductors, the coil of the inductors should handle at least 10 A of continual current, with peak current greater than 50 A. The magnetic type inductors may be used in order to reduce the size of the EMI isolator 4. A female AC input socket 20 also may be added, in order to use a regular computer's AC power cord.

Preferred Embodiment—Operation

The primary function of PLC network device 2 is to perform networking functions through the regular power line. When the computer apparatus 3 has a network data packet which needs to be sent to other computers or peripheral devices, it puts the packet on the computer data bus 33. The packet is then transferred to the computer bus connector 31 through computer data bus interface 35. Then the bus cable 37 transmits the data packet to bus connector 22. The data bus interface 26 receives the data packet from bus connector 22 and transfers to the PLC data transceiver 5. The PLC data transceiver 5 converts the base-band network data signal to PLC signal 23. Finally, the PLC signal 23 is placed onto the power line 10 through the female AC input socket 20, AC power cord 12 and AC power outlet box 1.

In the opposite direction, when the PLC data transceiver 5 receives a PLC signal 23 from power line 10, the signal is converted to a base-band network data signal which is transmitted goes through the bus cable 37, computer bus interface 35 finally to the computer data bus 33.

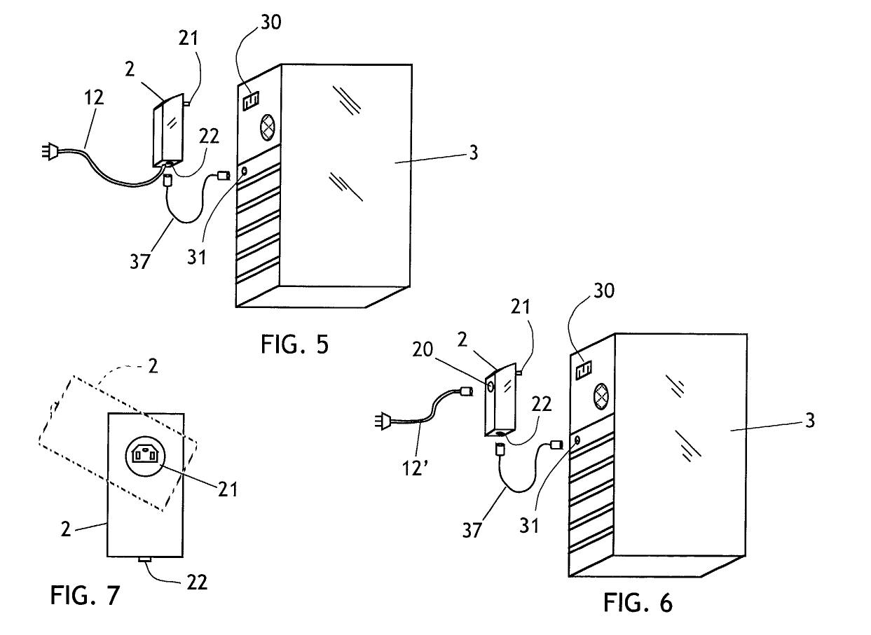

With regard to FIG. 5 the PLC network device 2 may be housed in a small enclosure similar in size to a typical wall socket-mounted DC power supply known in the prior art. The male AC output plug 21 plugs into the computer power input socket 30, which is usually located in the back panel of computer housing 3. The data cable 37 connects between the bus connector 22 on the PLC network device enclosure 2 and the computer bus connector 31. An AC power cord 12 connects to an AC power outlet box 11.

Referring to FIG. 6, an alternative embodiment of the invention includes most of the components described previously in FIG. 5. The PLC network device 2 is provided with a female AC input socket 20 so that a typical computer AC power cord 12′ can be used.

With regard to FIG. 7, the male AC output plug 21 may be rotatable about an axis parallel to the blades of the plug 21. This feature permits the device 2 to engage a computer power input receptacle 30 at any convenient angle, whereby computers having various power input configurations may be accommodated with optimal ease.

Conclusion, Ramifications, and Scope

Accordingly, it can be seen that the PLC network system of this invention can be used for commercial and personal computers to provide computer networking via power line. The PLC network device is attached to a computer station, sharing a single main power cable for both AC power input as well as exchanging data with other devices on a computer network. Because the PLC network system is attached to the computer station, the installation is very simple: plug the PLC network device into the computer's power input socket, plug the power cord of the PLC network device into the wall AC outlet, and then connect a very short data cable to the computer bus plug connector. These steps provide computer power as well as computer data networking.

The plug compatible PLC network device has additional advantages in that:

It reduces the noise level at the base-band data bus side because the data cable is shorter.

It reduces the noise level at PLC data transceiver side because the EMI filter blocks the noise emanating from the switched power supply.

It reduces cost and size by eliminating its own power supply, and instead using DC power from the computer system.

The angle of the enclosure and the male AC output plug may be changed to accommodate computers of many different configurations.

By attaching directly to the computer via the computer power input receptacle, the PLC network device does not occupy any horizontal desk space (a “zero footprint” factor), and the short data cable does not become entangled with other computer cables or wires.

Although the description above contains many specifics, these should not be construed as limiting the scope of the invention but as merely providing illustrations of some of the presently preferred embodiments of this invention. For example, (1) the bus interface will support any other kinds of buses, such as ISA bus, PCI bus, IDE bus, SCSI bus, etc. It also will support other kinds of communication ports, such as any parallel port or any serial port. It also can be a special kind of bus that directly connects to a data communication chipset on the computer motherboard or a plug-in PC card. (2) The enclosure of PLC network device is attached to the computer enclosure. It is not limited to attachment to the AC power socket. (3) The system may draw operating power from the computer main power supply, but may also be self-powered, if necessary. (4) The network device enclosure may be provided with suitable connectors. (5) Any computer peripheral device that draws power from an AC line connection may be joined to the PLC network by employing the apparatus of this invention. In this regard, note that the terms computer, computer device, computer peripheral device, and computer station are used interchangeably herein to broadly include all such apparatus.

Thus the scope of the invention should be determined by the appended claims and their legal equivalents, rather than by the examples given.

1. A power line communication network device, including:
power line communication data transceiver means for transmitting and receiving computer system data over an AC power line;
a housing for enclosing said data transceiver means;
means for connecting to an AC power line;
means for connecting to an AC power input port of a computer device and transmitting AC power to said computer device;
said means for connecting to an AC power input port of a computer device further serving to secure said housing to said computer device; and,
means for transmitting and receiving computer system data between said data transceiver means and the computer device.

2. The power line communication network device of claim 1, wherein said means for connecting to an AC power input port includes a plug connector adapted to matingly engage the input port of the computer device.

3. The power line communication network device of claim 1, wherein said means for transmitting and receiving between said transceiver means and the computer device includes a data cable extending from said housing to the computer device.

4. The power line communication network device of claim 3, wherein the computer device further provides DC operating power for said power line communication network device.

5. The power line communication network device of claim 4, wherein said data cable conducts said DC operating power from the computer device to said network device.

6. The power line communication network device of claim 4, wherein said network device includes DC power distributor means.

7. The power line communication network device of claim 6, wherein said DC power distributor means includes at least one DC voltage regulator.

8. The power line communication network device of claim 1, further including an EMI isolator connected between said means for connecting to an AC power plug receptacle and said means for connecting to an AC power input port of a computer device.

9. The power line communication network device of claim 8, wherein said EMI isolator is disposed within said housing.

10. The power line communication network device of claim 8, wherein said EMI isolator is adapted to filter out electromagnetic noise emanating from a switched power supply in the computer device.

11. The power line communication network device of claim 2, wherein said plug connector comprises a male plug.

12. The power line communication network device of claim 2, wherein said plug connector is rotatably mounted to said housing.

13. The power line communication network device of claim 8, wherein said EMI isolator includes a dual Pi LC noise filter.

14. The power line communication network device of claim 8, wherein said EMI isolator includes an L-configuration LC noise filter.
